(19) United States
(12) Patent Application Publication
(10) Pub. No.: US 2025/0372673 A1
(43) Pub. Date: Dec. 4, 2025

(54) FUEL CELL POWER GENERATION SYSTEM AND CONTROL METHOD THEREOF

(71) Applicants: FUZHOU UNIVERSITY, Fuzhou, Fujian Province (CN); FZU ZIJIN HYDROGEN POWER TECHNOLOGY CO., LTD, Fuzhou City, Fujian Province (CN)

(72) Inventors: Lilong JIANG, Fuzhou (CN); Tianying YANG, Fuzhou (CN); Yu LUO, Fuzhou (CN); Chongqi CHEN, Fuzhou (CN); Li LIN, Fuzhou (CN)

(73) Assignees: FUZHOU UNIVERSITY, Fuzhou, Fujian Province (CN); FZU ZIJIN HYDROGEN POWER TECHNOLOGY CO., LTD, Fuzhou City, Fujian Province (CN)

(21) Appl. No.: 18/874,699

(22) PCT Filed: Jun. 18, 2023
(86) PCT No.: PCT/CN2023/100917

§ 371 Date: Dec. 13, 2024

(30) Foreign Application Priority Data
Jun. 21, 2022 (CN) 202210705379.0

(51) Int. Cl. H01M 8/04119; C01B 3/04; H01M 8/04014; H01M 8/04082; H01M 8/04223; H01M 8/04746; H01M 8/22; H01M 16/00

(52) U.S. Cl. CPC H01M 8/04179; C01B 3/047; H01M 8/04022; H01M 8/04164; H01M 8/04201; H01M 8/04268; H01M 8/04776; H01M 8/222; H01M 16/003

(57) ABSTRACT

A fuel cell power generation system and a control method thereof. The system includes ammonia decomposition device, ammonia removal device, fuel cell, first membrane humidifier, second membrane humidifier, first gas-water separator and air compressor, the first membrane humidifier is communicated between the ammonia decomposition device and anode of the fuel cell, the second membrane humidifier is communicated between the air compressor and cathode of the fuel cell, the air compressor is configured to feed compressed air into the cathode of the fuel cell; first outlet of the fuel cell is communicated with the anode of the fuel cell, and second outlet of the fuel cell is communicated with ingress of the first gas-water separator, a first egress of the first gas-water separator is communicated with the first membrane humidifier, and a second egress of the first gas-water separator is communicated with the second membrane humidifier.

### CROSS REFERENCE TO RELATED APPLICATION

This patent application is a national stage application of International Patent Application PCT/CN2023/100917 filed on Jun. 18, 2023 which claims the benefit and priority of Chinese Patent Application No. 202210705379.0 filed with the China National Intellectual Property Administration on Jun. 21, 2022. The contents of the above applications are incorporated by reference herein in their entireties as part of the present application.

### TECHNICAL FIELD

This disclosure relates to the technical field of fuel cells, and specifically to a fuel cell power generation system and a control method thereof.

### BACKGROUND

A fuel cell is a chemical device that converts the chemical energy of fuel directly into electrical energy, mainly through the electrochemical reaction between oxygen or other oxidants and the fuel, in which the fuel and air are fed into the anode and cathode of the fuel cell respectively, and electricity can then be produced. Hydrogen fuel is currently the most ideal fuel applied in the fuel cell, which has high efficiency and the fuel product of water, and does not produce ash or exhaust gas and pollute environment pollution. However, the storage of hydrogen is difficult, and at present ammonia is generally used as an alternative fuel for hydrogen gas. Ammonia has a high hydrogen content, and has advantages of easy liquefaction, high energy density, no carbon emission, high safety, and low fuel cost, etc.

Proton exchange membrane fuel cell, briefly referred to as PEMFC, are currently a mainstream technology. There are mainly two issues in an application process. One issue is that protons in the perfluoro sulfonic acid membrane in the PEMFC may react with the high-concentration ammonia to generate NH⁴⁺ ions, which easily results in irreversible degradation of the PEMFC performance, and requires to couple with a series of components and devices, such as ammonia decomposition, ammonia removal, hydrogen fuel cell, etc. The efficient integration of these components and devices involves complex energy management and system control strategies, and may easily lead to unstable operation and high energy consumption of the ammonia fuel cell system. The other issue is that only the cathode of the fuel cell is generally humidified in the prior art, and when a proton membrane of a fuel cell stack is relatively thick, an anode side of the fuel cell is prone to membrane drying.

Chinese patent publication No. CN110277578 A discloses an ammonia fuel cell system and electric device, including an ammonia decomposition reaction device, a heating device, a hydrogen fuel cell, and a DC/DC converter and an inverter, a battery pack and a heat exchanger connected in sequence, which can be operated stably for a long time and form a recycling, and have the advantages of high flexibility, low energy consumption, and high system utilization. The patented technology has addressed the first issue. There is a need to address the second issue mentioned above.

### SUMMARY

In view of the deficiencies in the prior art, this disclosure aims to address an issue that an anode side of the fuel cell is prone to membrane drying when a proton membrane of the existing fuel cell stack is relatively thick. Therefore, this disclosure provides a fuel cell power generation system and a control method thereof.

This disclosure adopts the technical solutions as follows:

In one aspect, this disclosure provides a fuel cell power generation system, including:
an ammonia decomposition device and a heating device disposed in the ammonia decomposition device, wherein the heating device is configured to heat gas and catalyst in the ammonia decomposition device, and the ammonia decomposition device is configured to decompose ammonia gas into hydrogen and nitrogen gases;
an ammonia removal device communicated with an outtake of the ammonia decomposition device and configured to remove undecomposed ammonia gas;
a fuel cell communicated with the ammonia removal device and configured to generate electric energy by oxidizing hydrogen gas as fuel;
a conversion device connected to the fuel cell and configured to boost a voltage of the fuel cell; and
a battery pack configured to store the electric energy generated by the fuel cell;
wherein the system further includes a first membrane humidifier, a second membrane humidifier, a first gas-water separator and an air compressor; the first membrane humidifier is communicated between the ammonia decomposition device and an anode of the fuel cell, the second membrane humidifier is communicated between the air compressor and a cathode of the fuel cell, and the air compressor is configured to feed compressed air into the cathode of the fuel cell; a first outlet of the fuel cell is communicated with the anode of the fuel cell, and a second outlet of the fuel cell is communicated with an ingress of the first gas-water separator, a first egress of the first gas-water separator is communicated with the first membrane humidifier, and a second egress of the first gas-water separator is communicated with the second membrane humidifier.

Further, the system further includes a membrane separation device and a variable pressure adsorption separation device, an input port of the variable pressure adsorption separation device is communicated with an output port of the membrane separation device, an output port of the ammonia removal device is communicated with an input port of the membrane separation device, and an output port of the variable pressure adsorption separation device is communicated with the anode of the fuel cell through the first membrane humidifier.

Further, the system further includes a hydrogen gas pressure pump connected between the output port of the ammonia removal device and the input port of the membrane separation device.

Further, the system further includes an ejector, and an inlet port of the ejector is communicated with the first outlet of the fuel cell, a first outlet port of the ejector is individually communicated with the output port of the variable pressure adsorption separation device and an intake of the ammonia decomposition device, and a second outlet port of the ejector is communicated with the anode of the fuel cell.

Preferably, the heating device includes an electric heater and a tail gas combustion device, and the ammonia decomposition device is internally separated into a first decomposition space and a second decomposition space that are capable of conducting heat, and the tail gas combustion device is mounted in the first decomposition space, and the electric heater is mounted in the second decomposition space; and the first decomposition space is individually communicated with a first intake of the ammonia decomposition device and the first outlet port of the ejector, the second decomposition space is communicated with a second intake of the ammonia decomposition device, and ammonia gas enters the second decomposition space, and both the first decomposition space and the second decomposition space are communicated with the outtake of the ammonia decomposition device.

Preferably, the second decomposition space is filled with two catalysts in a flow direction of the ammonia gas, a proportion of a first catalyst is gradually increasing adjacent to an upstream side of the ammonia gas, and a proportion of a second catalyst is gradually increasing adjacent to a downstream side of the ammonia gas.

Further preferably, the first catalyst is a Ru-based catalyst, and the second catalyst adopts a Ni-based catalyst, and each catalyst is distributed and filled in a gradient, and each catalyst has a particle size of 0.5 mm to 3 mm.

In another aspect, this disclosure provides a fuel cell power generation system including:
an ammonia decomposition device and a heating device disposed in the ammonia decomposition device, wherein the heating device is configured to heat gas and catalyst in the ammonia decomposition device, and the ammonia decomposition device is configured to decompose ammonia gas into hydrogen and nitrogen gases;
an ammonia removal device communicated with an outtake of the ammonia decomposition device and configured to remove undecomposed ammonia gas;
a fuel cell communicated with the ammonia removal device and configured to generate electric energy by oxidizing hydrogen gas as fuel;
a conversion device connected to the fuel cell and configured to boost a voltage of the fuel cell; and
a battery pack configured to store the electric energy generated by the hydrogen fuel cell;
wherein the system further includes a pressure pump, a hydrogen gas circulation pump, a third membrane humidifier, a second gas-water separator and an air compressor, an inlet of the pressure pump is connected to an output port of the ammonia removal device, an outlet of the pressure pump is connected to an anode of the fuel cell, and the air compressor is configured to feed compressed air into the pressure pump; and
the third membrane humidifier is communicated between the pressure pump and a cathode of the fuel cell; a first outlet of the fuel cell is communicated with an ingress port of the hydrogen gas circulation pump, a first egress port of the hydrogen gas circulation pump is communicated with the intake of the ammonia decomposition device, a second egress port of the hydrogen gas circulation pump is communicated with the anode of the fuel cell, a second outlet of the fuel cell is communicated with an ingress of the second gas-water separator, and an egress of the second gas-water separator is communicated with the third membrane humidifier.

Further, the system further includes a hydrogen gas pressure pump and a membrane separation device, wherein a first output port of the membrane separation device is communicated with the first egress port of the hydrogen gas circulation pump, a second output port of the membrane separation device is communicated with the pressure pump, an ingress port of the hydrogen gas pressure pump is communicated with the output port of the ammonia removal device, and the egress of the hydrogen gas pressure pump is communicated with an input port of the membrane separation device.

This disclosure further provides a method for controlling a fuel cell power generation system, including steps as follows:
S101, starting the heating device, and feeding ammonia gas into the ammonia decomposition device when reaching a preset temperature inside the ammonia decomposition device, to decompose the ammonia gas into hydrogen and nitrogen gases;
S102, feeding the decomposed hydrogen and nitrogen gases into the ammonia removal device to remove an undecomposed ammonia gas;
S103, feeding the hydrogen and nitrogen gases after ammonia removal into the hydrogen gas pressure pump to pressurize the hydrogen and nitrogen gases to a preset pressure;
S104, feeding the pressurized hydrogen and nitrogen gases into the membrane separation device and performing a first separation of hydrogen gas, and feeding the hydrogen and nitrogen gases after the membrane separation into the variable pressure adsorption separation device and performing a second separation of the hydrogen gas;
S105, feeding the separated hydrogen and nitrogen gases into the anode of the fuel cell after adjusting the humidity by the first membrane humidifier, and feeding the compressed air into the cathode of the fuel cell after adjusting the humidity by the second membrane humidifier; wherein a gas produced by the anode of the fuel cell returns to the ammonia decomposition device, the variable pressure adsorption separation device, and the anode of the fuel cell under an action of the ejector, and a gas produced by the cathode of the fuel cell is separated into air and water by the first gas-water separator, and the first gas-water separator individually feeds the separated water into the first membrane humidifier and the second membrane humidifier; and
S106, boosting the voltage of the fuel cell by the conversion device, and storing a generated electrical energy in the battery pack.

This disclosure further provides a method for controlling a fuel cell power generation system, including steps as follows:
S201, starting the heating device, and feeding ammonia gas into the ammonia decomposition device when reaching a preset temperature inside the ammonia decomposition device, to decompose the ammonia gas into hydrogen and nitrogen gases;
S202, feeding the decomposed hydrogen and nitrogen gases into the ammonia removal device to remove an undecomposed ammonia gas;
S203, feeding the hydrogen and nitrogen gases after ammonia removal into the hydrogen gas pressure pump to pressurize the hydrogen and nitrogen gases to a preset pressure;
S204, feeding the pressurized hydrogen and nitrogen gases into the membrane separation device and performing a membrane separation of hydrogen gas, and feeding the hydrogen and nitrogen gases after membrane separation into the anode of the fuel cell after pressurization by the pressurization pump; feeding a compressed air into the third membrane humidifier after pressurization by the pressurization pump and then into the cathode of the fuel cell after adjusting the humidity by the third membrane humidifier; wherein a gas produced by the anode of the fuel cell returns to the ammonia decomposition device, the membrane separation device and the anode of the fuel cell under an action of the hydrogen gas circulation pump, and a gas produced by the cathode of the fuel cell is separated into air and water by the second gas-water separator, and the second gas-water separator feeds the separated water into the third membrane humidifier; and
S205, boosting the voltage of the fuel cell by the conversion device, and storing a generated electrical energy in the battery pack.

The technical solutions of this disclosure have advantages as follows:
A) The fuel cell power generation system provided by this disclosure is provided with membrane humidifiers at the anode and cathode of the hydrogen fuel cell, respectively, which can humidify the anode and cathode of the fuel cell, respectively, thereby solving the issue that the anode side of the fuel cell is prone to membrane drying when the proton membrane of the fuel cell stack is relatively thick under the condition that only the cathode of the fuel cell is humidified in the prior art.
B) In the present disclosure, the first membrane humidifier, the second membrane humidifier, and the third membrane humidifier all adopt Nafion™ membranes. The water obtained from the first gas-water separator at the cathode side of the fuel cell is unidirectionally fed to one side of the first membrane humidifier at the anode side of the fuel cell. Hydrogen gas cannot penetrate outside in the case that water is on one side of the Nafion™ membrane and hydrogen gas is on the other side thereof. Compared with humidifying the anode of hydrogen fuel cell by using humid air, the fuel cell power generation system can not only reduce the system volume, but also fundamentally solve the issue that the anode side of the fuel cell is prone to membrane drying.

### BRIEF DESCRIPTION OF THE DRAWINGS

In order to more clearly illustrate specific embodiments of this disclosure, accompanying drawings that need to be used in the specific embodiments will be introduced briefly below. Obviously, the accompanying drawings described below are some of the embodiments of this disclosure, and other accompanying drawings can be obtained according to these accompanying drawings for the person skilled in the field without creative labors.

FIG. 1 shows a configuration diagram of a fuel cell power generation system provided in Embodiment I of this disclosure;

FIG. 2 shows a configuration diagram of a fuel cell power generation system provided in Embodiment II of this disclosure;

FIG. 3 shows a flowchart of a method for controlling the fuel cell power generation system provided in Embodiment I; and

FIG. 4 shows a flowchart of a method for controlling the fuel cell power generation system provided in Embodiment II.

### REFERENCE NUMERALS

1: ammonia decomposition device; 2: heating device; 3: first control valve; 4: ammonia removal device; 5: second control valve; 6: hydrogen gas pressure pump; 7: membrane separation device; 8: third control valve; 9: variable pressure adsorption separation device; 10: fourth control valve; 11: first membrane humidifier; 12: ejector; 13: fuel cell; 14: first gas-water separator; 15: second membrane humidifier; 16: air compressor; 17: DC/DC converter; 18: battery pack; 19: capacitor; 20: direct current load; 21: alternating current load; 22: pressure pump; 23: hydrogen gas circulation pump; 24: third membrane humidifier; 25: second gas-water separator.

### DETAILED DESCRIPTION OF THE EMBODIMENTS

Hereinafter, the technical solutions of this disclosure will be described clearly and completely in conjunction with the accompanying drawings. Obviously, the described embodiments are a part, not all of the embodiments of this disclosure. Based on the embodiments in this disclosure, all other embodiments obtained by the person skilled in the art without creative efforts fall within the scope of this disclosure.

In the description of this disclosure, it should be understood that the terms for indicating orientation or position relationships, such as “center”, “upper”, “lower”, “left”, “right”, “vertical”, “horizontal”, “inside”, “outside” and the like, are based on the orientation or position relationships shown in the figures, and are intended only for facilitating the description of this disclosure and simplifying the description, and are not intended to indicate or suggest that the device or element referred to must be of a particular orientation, be constructed and be operated with a particular orientation, and therefore are not to be construed as limitations of this disclosure. Furthermore, the terms “first”, “second”, “third” are used for descriptive purposes only, and are not to be understood as indicating or suggesting relative importance.

In the description of this disclosure, it should be understood that, unless otherwise expressly specified and limited, the terms “mounting”, “joining”, “connecting”, should be understood in a broad sense. For example, they can be fixed connection, detachable connection, or integrated connection; they can be mechanical connection or electrical connection; they can be direct connection, indirect connection through an intermediate medium, or internal communication between two elements. For the person skilled in the art, the specific meaning of the above terms in the context of this disclosure can be understood under specific circumstances.

### Embodiment I

As shown in FIG. 1, this disclosure provides a fuel cell power generation system, which includes an ammonia decomposition device 1, a heating device 2, an ammonia removal device 4, a fuel cell 13, a conversion device, a battery pack 18, a first membrane humidifier 11, a second membrane humidifier 15, a first gas-water separator 14, and an air compressor 16, etc.

The heating device 2 is disposed in the ammonia decomposition device 1 and configured to heat gas and catalyst, and the ammonia decomposition device 1 is configured to decompose ammonia gas into hydrogen and nitrogen gases.

An input port of the ammonia removal device 4 is communicated with an outtake of the ammonia decomposition device 1, and the ammonia removal device 4 is configured to remove undecomposed ammonia gas. The fuel cell 13 is communicated with the ammonia removal device 4 and is configured to generate electric energy by oxidizing hydrogen gas as fuel. The conversion device is connected to the fuel cell 13 and configured to boost a voltage of the fuel cell 13. The battery pack 18 is configured to store the electric energy generated by the fuel cell 13. The first membrane humidifier 11 is communicated between the ammonia decomposition device 1 and an anode of the fuel cell 13. The second membrane humidifier 15 is communicated between the air compressor 16 and a cathode of the fuel cell 13. The air compressor 16 is configured to feed compressed air into the cathode of the fuel cell 13. A first outlet of the fuel cell 13 is communicated with the anode of the fuel cell 13, and a second outlet of the fuel cell 13 is communicated with an ingress of the first gas-water separator 14. A first egress of the first gas-water separator 14 is communicated with the first membrane humidifier 11, and a second egress of the first gas-water separator 14 is communicated with the second membrane humidifier 15.

In the fuel cell power generation system described above, the anode and the cathode of the hydrogen fuel cell each are provided with a membrane humidifier which adopts a Nafion™ membrane, solving the issue of humidifying only the cathode of the fuel cell in related art, and the issue that anode side of the fuel cell is prone to membrane drying when the proton membrane of the fuel cell stack is relatively thick. In this disclosure, the anode of the hydrogen fuel cell is humidified. One way involves unidirectionally feeding the water obtained from the first gas-water separator 14 at the cathode side of the fuel cell 13 to a side of the first membrane humidifier 11 at the anode side of the fuel cell 13, because hydrogen gas cannot penetrate outside in the case that water is on one side of the Nafion™ membrane and hydrogen gas is on the other side thereof. Another way involves humidifying by adopting exhaust gas from the anode of the fuel cell 13, meanwhile ensuring the purity of the hydrogen gas in the anode. However, the humidification by the exhaust gas from the anode of the fuel cell 13 is insufficient. In this disclosure, the former humidification way may be adopted, and of course, a combination of the both ways described above is a most preferable method proposed in this embodiment, which can not only reduce a system volume, but also fundamentally solve the issue that the anode side of the fuel cell 13 is prone to membrane drying. If wet air is used to humidify the anode of the fuel cell 13, it can lead to hydrogen gas permeation, which can further result in lowering hydrogen gas concentration to a point where the operation cannot be performed because hydrogen and nitrogen gases are used in the system. During operation, a humidification capacity is regulated and controlled according to feedback from operation parameters of the stack, with a humidity control range of 10% RH to 90% RH and a temperature control range of 10° C. to 45° C.

In the present embodiment, the system further includes a membrane separation device 7 and a variable pressure adsorption separation device 9, an output port of the membrane separation device 7 is connected to an input port of the variable pressure adsorption separation device 9, an input port of the membrane separation device 7 is connected to an output port of the ammonia removal device 4, and an output port of the variable pressure adsorption separation device 9 is connected to an import of the first membrane humidifier 11. A volume ratio of hydrogen gas to nitrogen gas in the hydrogen and nitrogen gases after ammonia removal is 3:1. The hydrogen and nitrogen gases after ammonia removal are separated and purified by coupling the membrane separation device 7 with the variable pressure adsorption separation device 9, wherein the gases at first enter the membrane separation device 7 and then enter the variable pressure adsorption separation device 9, and the circulation gases after the variable pressure adsorption separation are returned to the membrane separation device 7 for recirculation. A sequency of the membrane separation device 7 and the variable pressure adsorption separation device 9 cannot be reversed, because an upper limit of the hydrogen gas concentration separated by the membrane separation device 7 is 95%. Although a cost is low and a performance is good under all working conditions, this concentration of hydrogen gas does not satisfy a demand for a system of the fuel cell 13. An upper limit of the hydrogen gas concentration separated by the variable pressure adsorption separation device 9 can reach up to 99.97% to 99.999%, which can achieve a high purity, but a cost is high. It cannot adapt to changes of the working conditions, and the yield is very low at low working conditions. After research, the inventor has found that by combining the membrane separation and the variable pressure adsorption separation, both low and high working conditions can be handled, and both can obtain an extremely high yield. Therefore, the sequency of the membrane separation device 7 and the variable pressure adsorption separation device 9 cannot be reversed. The design can be adapted to multiple hydrogen gas concentrations at the same time. The yield is ensured in terms of the purification method, and the performances of the fuel cell 13 are ensured in terms of the humidification and the equivalence ratio.

In a specifical embodiment, the membrane separation device 7 can be selected from polymer membranes such as polysulfone, 2,6-dimethylphenyl ether (PPO), aromatic polyamide, polyimide, modified polycarbonate, and cellulose acetate, in which the hydrogen and nitrogen gases are subjected to hydrogen gas permeation separation at a temperature of 20° C. to 140° C. under a pressure difference of 0.1 MPa to 3.2 MPa between the two sides. The upper limit of the hydrogen gas concentration after membrane separation can reach 95%, and the upper limit of yield can reach 95%. After adsorption and separation in the variable pressure adsorption separation device 9, the purity of the hydrogen gas concentration can reach 99.97% to 99.999%, desorbed gases are returned to the membrane separation place for circulation.

In addition, the existing PEMFC stack systems cannot be operated stably under the hydrogen and nitrogen mixture gases, and yet the couple of the membrane separation device 7 and the variable pressure adsorption separation device 9 allows the operation stable.

In the present embodiment, a hydrogen gas pressure pump 6 is further provided, which is connected between the ammonia removal device 4 and the membrane separation device 7 and configured to pressurize the hydrogen and nitrogen gases. The ammonia decomposition reaction is a reaction in which the equilibrium shifts in the reverse direction as the pressure increases. With respect to the fuel cell 13, if the pressure of the hydrogen and nitrogen gases is low, it cannot reach a demand pressure of the stack of the fuel cell 13, which is in a range from 0.15 MPa to 0.2 MPa (1.5 bar to 2.0 bar), Therefore, the hydrogen gas pressure pump 6 is used to pressurize the hydrogen and nitrogen gases after ammonia removal to meet the demand of the fuel cell 13.

In the present embodiment, an ejector 12 is also provided in the system, an inlet port of the ejector 12 is communicated with the first outlet of the fuel cell 13, a first outlet port of the ejector 12 is individually communicated with the output port of the variable pressure adsorption separation device 9 and an intake of the ammonia decomposition device 1, and a second outlet port of the ejector 12 is communicated with the anode of the fuel cell 13. On one hand, the ejector 12 can return the gas generated correspondingly by the anode of the fuel cell 13 to the anode of the fuel cell 13, which can allow the hydrogen to be oxidized cyclically, and can also play a certain humidifying effect on the hydrogen gas; on another hand, it can also return the gas generated correspondingly by the anode of the fuel cell 13 to the variable pressure adsorption device, and pass through the first membrane humidifier 11, and then enter the anode of the fuel cell 13 again; and on yet another hand, it can also return the gas generated correspondingly by the anode of the fuel cell 13 to the ammonia decomposition device 1, so that an internal temperature of the ammonia decomposition device 1 can be maintained by the heat of the tail gas, and meanwhile the hydrogen gas can be recycled.

In the present embodiment, the heating device 2 includes an electric heater and a tail gas combustion device, and an interior of the ammonia decomposition device 1 includes two decomposition spaces that are not only separated from each other but also can conduct heat conduction. A first decomposition space is communicated with the first outlet port of the ejector 12 through the first intake of the ammonia decomposition device 1, and the tail gas combustion device is mounted in the first decomposition space. The ammonia gas can enter a second decomposition space through the second intake of the ammonia decomposition device 1, and the electric heater is mounted in the second decomposition space. Both the first decomposition space and the second decomposition space are communicated with the outtake of the ammonia decomposition device 1. The second decomposition space is filled with two catalysts in a flow direction of the ammonia gas, a proportion of the first catalyst gradually increases toward an upstream side of the ammonia gas, and a proportion of the second catalyst gradually increases toward a downstream side of the ammonia gas.

The tail gas combustion device is mainly configured to supply heat, and the electric heater is configured to control temperature. The combustion device is a microchannel reactor for catalytic oxidation and heat release of the tail gas, in which a concentration of hydrogen gas in the tail gas is in a range from 20% to 70%. The electric heater plays the role of controlling the temperature and supplementing heat, including but not limited to the use of surrounding fins to contact, with another side of the fins embedded in a catalyst bed of an inner tube and other ways, in order to enhance heat exchange. The electric heater can be used to additionally give the thermal power adjacent to the downstream side of the gas according to instructions of the temperature control, and ensure performances of the catalyst such as Ni-based catalysts under the pressure of 0.4 Mpa. The microchannel reactor has a function of exchanging heat between a low-temperature gas and a high-temperature gas entering the device, realizing that an intake gas temperature of the low-temperature gas is in a range from −5° C. to 45° C., a temperature at which it reaches the catalyst bed is in a range from 450° C. to 600° C., and the high-temperature gas leaving the ammonia decomposition reactor after decomposition has a temperature of less than 150° C.

The first catalyst preferably adopts a Ru-based catalyst, and the second catalyst preferably adopts a Ni-based catalyst. In the flow direction of ammonia gas, the Ru-based catalyst and Ni-based catalyst each are loaded and filled from top to bottom and each are distributed in a gradient. The catalysts each have particle sizes of 0.5 mm to 3 mm, and have shapes which are not limited to spherical porous particles and elongated porous particles. The operating temperature in the upstream part is 480° C., and the downstream part can be operated at a temperature of 500° C. to 650° C. according to the instructions. The tail gas combustion device adopts hydrogen gas catalytic oxidation, with an operating concentration range of 20% to 70%.

Moreover, the more adjacent to the upstream side of the gas, the higher the proportion of Ru-based multi-phase catalyst, and the more adjacent to the downstream side of the gas, the higher the proportion of Ni-based catalyst. The spatial distribution of the proportions of the two catalysts includes, but is not limited to, a variety of component distribution manners, such as arbitrary mixing, linear distribution. When the ammonia decomposition temperature in the bed is at 480° C., a decomposition rate of 99.8% is reached, and a decomposition rate of 99.8% can be reached by using a method of increasing the temperature gradient at a pressure of 0.4 Mpa and a space velocity of 10000 mL (gcat·h). The above decomposition rate refers to the one-way conversion rate of hydrogen production by means of ammonia decomposition. Since the ammonia decomposition reaction is a reaction in which the equilibrium shifts in the reverse direction as the pressure increases, pressurization is a great challenge for the catalyst. The idea of industrial treatment is to increase the temperature. However, the Ru-based catalyst cannot be carried out at too high temperatures due to some reasons, otherwise the carrier may be dissociated and pulverized in structural mechanics, and absorbing heat drastically in the intake gas end may happen in the system in the kinetics, which makes it impossible to effectively control a temperature of a pinch point of the heat exchange, and the heat exchange efficiency decreases drastically. This is why we adopt the gradient distribution arrangement of the upper and lower layers of the Ru-based and Ni-based catalysts, so that the heat dissipation can be evenly spread over the entire tube pass.

For the function of the catalysts, it will be further explained that the Ru-based catalyst has a low activation temperature and a high conversion rate, but the carrier is not heat-resistant. If a high-pressure operation is adopted, it is required to increase the temperature, which can lead to a rapid heat absorption in a front part of the tube, resulting in a substantial decrease in the heat change efficiency, and can lead to a high temperature at a back part of the tube, pulverizing the catalysts. The Ni-based catalyst has a high activation temperature, which requires a relatively high temperature. If only the Ni-based catalyst is used, a relatively low temperature may occur in the front part of the tube, the heat transfer efficiency may be decreased sharply, and the system volume may be increased substantially, which makes it become a design that is realizable but difficult for practical application, so the integration use of the two catalysts is necessary.

In the fuel cell power generation system described above, the ammonia decomposition device 1 is provided with a first intake, a second intake, and an outtake, the first intake of the ammonia decomposition device 1 is communicated with the ejector 12, the second intake of the ammonia decomposition device 1 is communicated with an ammonia storage tank via a flow meter, and the outtake of the ammonia decomposition device 1 is communicated with the ammonia removal device 4. In specific implementation, the interior of the ammonia decomposition device 1 is separated into the first decomposition space and the second decomposition space by a heat-conducting metal structure. As an embodiment, the heat-conducting metal structure is a heat-conducting metal plate, and the first decomposition space and the second decomposition space are spaced apart on the left and right sides. As another embodiment, the heat-conducting metal structure is a tubular structure, and the tail gas enters into the first decomposition space within the tubular shape, and the ammonia gas enters into the second decomposition space outside the tubular shape. Compared with the heat-conducting metal plate, the tubular structure can allow the combustion heat of the tail gas to well heat the second decomposition space, improving the heat utilization efficiency of the tail gas.

In the fuel cell power generation system described above, the first membrane humidifier 11 and the ejector 12 are combined to control the humidity of the hydrogen gas entering the anode of the fuel cell 13, and the second membrane humidifier 15 and the air compressor 16 are combined to control the humidity of the air entering the cathode of the fuel cell 13, so as to control the humidity of the hydrogen gas of the fuel cell 13 by using the combination of the first membrane humidifier 11, the second membrane humidifier 15, the ejector 12, and the air compressor 16. The ejector 12 is adopted to return the tail gas produced by the anode of the fuel cell 13 to the ammonia decomposition device 1, so that the heat of the tail gas is effectively utilized. Moreover, the tail gas combustion device is adopted to provide heat, and the electric heater is used to control the temperature, so as to control the temperature of the hydrogen gas of the fuel cell 13 by using the combination of the ejector 12, the tail gas combustion device 2, and the electric heater. The hydrogen gas pressurized by the hydrogen gas pressure pump 6 enters the anode of the fuel cell 13 from the first inlet of the fuel cell 13, the ejector 12 returns the tail gas of the fuel cell 13 to the anode of the fuel cell 13 via the first inlet of the fuel cell 13, and the air is compressed by the air compressor 16 and then enters the cathode of the fuel cell 13 from the second inlet of the fuel cell 13, so as to achieve a dynamic pressure balance with the tail gas outlet of the anode of the fuel cell 13. Therefore, the control of temperature, humidity, and pressure is achieved on the hydrogen gas at the first inlet of the fuel cell 13; stack anode exhaust gas at the first inlet of the fuel cell 13 are coupled, to control a gas equivalence ratio, humidity and pressure of the gas leaving the first outlet of the fuel cell 13, pressure, humidity and temperature of the air at the second inlet of the fuel cell 13 are controlled, and the dynamic pressure balance with the gas at the first outlet of the fuel cell 13 is also achieved.

The pressure control of the tail gas at the first outlet of the fuel cell 13 includes the hydrogen gas pressure pump 6 using a compressed air source based on the Pascal's principle, which pressurizes the gas at the first outlet of the fuel cell 13 by coupling the compressed air entering into the second inlet of the fuel cell 13. The pressure is controlled in a range from 0.1 MPa to 0.4 MPa. The absolute value of the gas pressurization at the first outlet of the fuel cell 13 is 1 time to 4 times the value of compressed air pressure drop. The pressure cooperative control is achieved by a controller, and the numerical difference between the first outlet pressure of the fuel cell 13 and the second outlet pressure of the fuel cell 13 is controlled within a range of 0 to MPa 0.08 MPa.

The hydrogen and nitrogen mixture gases are obtained from hydrogen production by ammonia decomposition, this causes they cannot be suitable for the system of the fuel cell 13 generally used for pure hydrogen, as the ejector 12 will directly stop working, and the circulation pump can also lead to nitrogen gas accumulation, with the key issues being the equivalence ratio and the humidity. In this embodiment, the control of the gas equivalence ratio at the first outlet of the fuel cell 13 adjusts the gas equivalence ratio into the system of the fuel cell 13 according to the purity parameters of both the membrane separation device 7 and the variable pressure adsorption separation device 9, the strategy of the humidification section, and the operation of the stack. The equivalence ratio is an equivalence ratio calculated based on the hydrogen gas consumed by the stack of the fuel cell 13, and is controlled in a range from 1.2 to 1.6. The pressure at the front end of the ejector 12 is controlled within a range of 1.35 MPa to 1.5 MPa.

The tail gas of the stack of the fuel cell 13 is utilized and controlled, the ejector 12 is used to pump the tail gas of the anode to the first inlet of the fuel cell 13, a rotational speed of the ejector 12 is controlled to realize the control on the equivalence ratio and the humidity, and a gas back-pressure adjustment is performed. The first membrane humidifier 11 and the second membrane humidifier 15 are utilized to reverse osmosis of gaseous water vapor from the cathode of the fuel cell 13 back to the second inlet of the fuel cell 13.

In the present embodiment, the fuel cell 13 adopts a proton exchange membrane, i.e. a proton exchange membrane fuel cell (PEMFC) stack with a perfluorosulfonic acid membrane and a modified membrane thereof as the electrolyte, or a high temperature PEMFC (HT-PEMFC) stack with a phosphoric acid-PBI doped or PBI/SiO₂ composite membrane as the electrolyte. The operating temperature is in a range from 50° C. to 90° C., a suitable gas is hydrogen gas with a purity of 75% to 99.999%, the concentration of ammonia gas is less than 0.1 ppm, a use humidity range is 10% RH to 95% RH, and a use air pressure range is 0.1 MPa to 0.4 MPa. For HT-PEMFC stack, the suitable gas is hydrogen gas with a purity of 75% to 99.999%, the concentration of ammonia gas is less than 100 ppm, the use humidity range is in a range from 60% to 99.9% RH, and the use air pressure range is in a range from 0.1 MPa to 0.3 MPa.

In the present embodiment, the air compressor 16 outputs 0.1 MPa to 0.4 MPa compressed air according to the controller. The flow rate is matched with the power of the stack of the fuel cell 13, and is adjusted in a range from 1.5 to 2.2 according to the equivalence ratio of air into the fuel cell 13. An air intake port of the air compressor 16 is equipped with an air filter to filter particles in the environment.

The present embodiment includes a plurality of ammonia removal devices, which adsorb ammonia in the hydrogen and nitrogen mixture gases out of the ammonia decomposition device by a physical adsorption method, wherein an adsorbent operating pressure is in a range of 0.1 MPa to 0.4 MPa, an operating temperature is in a range of 30° C. to 110° C., and the ammonia content of the gases after the adsorption by the device is less than 0.1 ppm, and the temperature is less than 45° C.

In the present embodiment, the conversion device adopts a DC/DC converter 17, which transmits electricity generated by the fuel cell 13 to an output terminal in a CC, CV or CP mode, and is connected with the battery pack 18 as well as an external direct current load 20 or alternating current load 21. A capacitor 19 and the battery pack 18 are equipped with BMS systems, which can respond to changes in external demand with a discharge rate of 0.1 C to 10 C, and can adapt to a direct current bus load with a DC/DC output terminal voltage.

The hydrogen fuel cell power generation system of this embodiment has advantages of high hydrogen energy storage density, high energy conversion efficiency, and low power generation cost. As a generator set, it has a great application prospect in the scenarios such as mines, construction sites, islands, oil field exploration, etc., far away from the power grid, or data centers, offshore platforms, etc., with larger power loads. Compared with the diesel genset of 2.5 RMB/kWh to 2.8 RMB/kWh, the ammonia-hydrogen fuel cell 13 has a use cost of 1.6 RMB/kWh. In addition, the system has less noise and no pollutant emission, which also has a great application advantage in some biomedical parks and hospitals scenarios. The application scenarios include generator sets, electric vehicles, electric ships, and the like.

An operating process of the fuel cell power generation system described above is as follows:

Ammonia gas enters the ammonia decomposition device 1 after passing through the flow meter, and the heating device 2 consisting of the electric heater and the tail gas combustion device supplies heat to heat ammonia gas and the catalysts so as to decompose ammonia gas into hydrogen and nitrogen gases. Specifically, the two ways are supplied heat together during startup, and after startup, the electric heating system only plays a role of temperature control, so that ammonia gas is decomposed into hydrogen gas and nitrogen gas in the catalyst bed, and the decomposition rate reaches more than 99.8%, and the decomposition pressure can be increased to 0.5 MPa according to a back-end demand by cooperation with the back-end electric heater and the bed layer with high content of Ni-based catalyst. The decomposed hydrogen and nitrogen gases pass through a first control valve 3 and then enter the ammonia removal device 4, to remove the undecomposed ammonia gas and obtain the hydrogen and nitrogen gases with the ammonia content less than 0.1 ppm. The hydrogen and nitrogen gases after ammonia removal passes through a second control valve 5 and then enters the hydrogen gas pressure pump 6; and the pressurized hydrogen and nitrogen gases enter the membrane separation device 7, and then enter the variable pressure adsorption separation device 9 after passing through a third control valve 8. The separated high-purity hydrogen (with a concentration more than 99.97%) passes through a fourth control valve 10 and then enters the first membrane humidifier 11, and the separated desorbed gases pass through the fourth control valve 10 and then return to the membrane separation device 7. After the separated high-purity hydrogen is adjusted the humidity through the first membrane humidifier 11, it enters the anode side of the fuel cell 13 along with the hydrogen gas returned from the ejector 12. The air is compressed by the air compressor 16, and then fed into the cathode side of the fuel cell 13 after adjusting the humidity through the second membrane humidifier 15. The anode gas of the fuel cell 13 passes through the fuel cell 13, and then the tail gas is discharged from the first outlet of the fuel cell 13 and flows back through the ejector 12. The cathode gas of the fuel cell 13 is discharged from the second outlet of the fuel cell 13, and then pass through the first gas-water separator 14, so that pollution-free air and water are discharged subsequently. The first gas-water separator 14 individually pumps the collected liquid water to the first membrane humidifier 11 and the second membrane humidifier 15 to maintain the water pressure of one side of each membrane. The electrical energy output from the fuel cell 13 is connected to the battery pack 18 and the capacitor 19 via the DC/DC converter 17, and is connected to the direct current load 20, an inverter and the alternating current load 21.

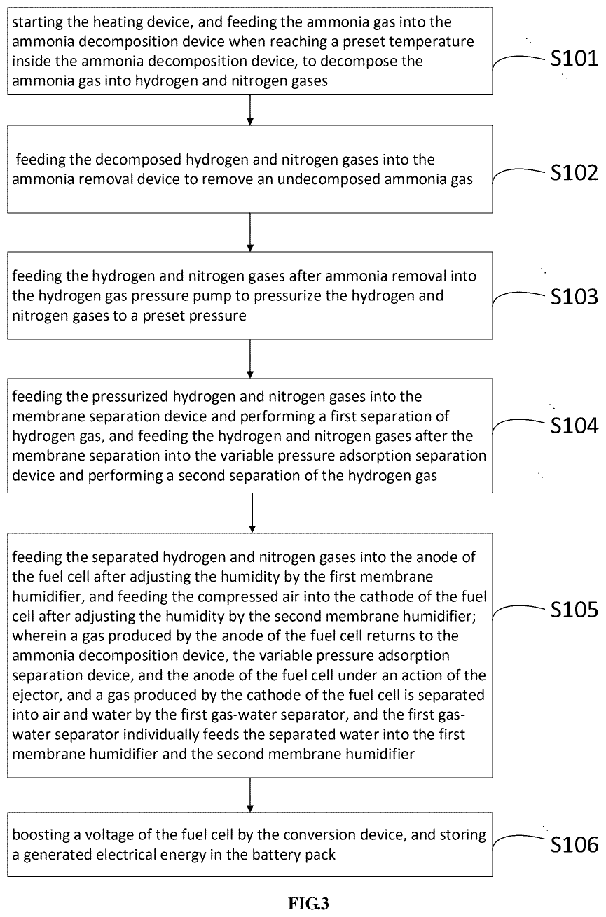

As shown in FIG. 3, a method for controlling a fuel cell power generation system includes the steps as follows:
S101, starting a heating device, and when a preset temperature is reached inside an ammonia decomposition device 1 (the temperature of an upstream portion of the ammonia decomposition device 1 reaches 480° C., and the temperature of a downstream portion thereof reaches 500° C. to 650° C.), feeding ammonia gas into the ammonia decomposition device 1 to decompose ammonia gas into hydrogen and nitrogen gases therein;
S102, feeding the decomposed hydrogen and nitrogen gases into an ammonia removal device 4 to remove the undecomposed ammonia gas;
S103, feeding the hydrogen and nitrogen gases after ammonia removal into a hydrogen gas pressure pump 6 to pressurize the hydrogen and nitrogen gases to a preset pressure (0.1 MPa to 0.4 MPa);
S104, feeding the pressurized hydrogen and nitrogen gases into a membrane separation device 7 and performing a first separation of hydrogen gas, and feeding the hydrogen and nitrogen gases after the membrane separation into a variable pressure adsorption separation device 9 and performing a second separation of the hydrogen gas;
S105, feeding the separated hydrogen and nitrogen gases into an anode of a fuel cell 13 after adjusting the humidity by a first membrane humidifier 11, and feeding compressed air into a cathode of the fuel cell 13 after adjusting the humidity by a second membrane humidifier 15; wherein the gas produced by the anode of the fuel cell 13 returns to the ammonia decomposition device 1, the variable pressure adsorption separation device 9, and the anode of the fuel cell 13 under the action of an ejector 12, and the gas produced by the cathode of the fuel cell 13 is separated into air and water by the first gas-water separator 14, and the first gas-water separator 14 individually feeds the separated water into the first membrane humidifier 11 and the second membrane humidifier 15; and
S106, boosting a voltage of the fuel cell 13 by a conversion device, and storing the generated electrical energy in a battery pack 18.

In addition to the effects set forth above, the fuel cell power generation system of this embodiment has beneficial effects including:

Compared with ammonia combustion and ammonia direct oxidation fuel cells (excluding SOFC), after hydrogen produced after the ammonia decomposition enters the fuel cell, the efficiency of electricity generation is high, and high-grade electrical energy is obtained. Compared with other devices and methods for production of hydrogen by ammonia decomposition that rely on high temperatures (800° C. to 900° C.), the catalysts for production of hydrogen by the ammonia decomposition below 500° C. used in this disclosure has higher energy efficiency. Compared with a single ammonia decomposition catalyst loading device with similar reaction temperatures, this disclosure also realizes production of hydrogen by ammonia decomposition at a higher gas pressure at the same decomposition rate by adjusting the relationship between the catalyst ratio and the temperature of the catalyst bed.

The embodiment can adjust the anode gas pressure, humidity and equivalence ratio, inhibit a negative impact of the nitrogen component on the fuel cell performance, and realize the double advantages of reducing investment in the variable pressure adsorption equipment and decreasing performance temperature of the fuel cell when hydrogen gas with a purity of 95% is provided through the membrane separation.

The embodiment utilizes compressed air from an air compressor to pressurize hydrogen gas, which achieves temperature control of the pressure difference between hydrogen gas and air. At the same time, according to this disclosure, since the hydrogen gas tail gas is fully utilized for combustion and heat exchange, the ammonia fuel cell system neither requires additional consumption of other fuels, nor requires using a relatively high proportion of electrical energy to heat the ammonia decomposition hydrogen production device.

### Embodiment II

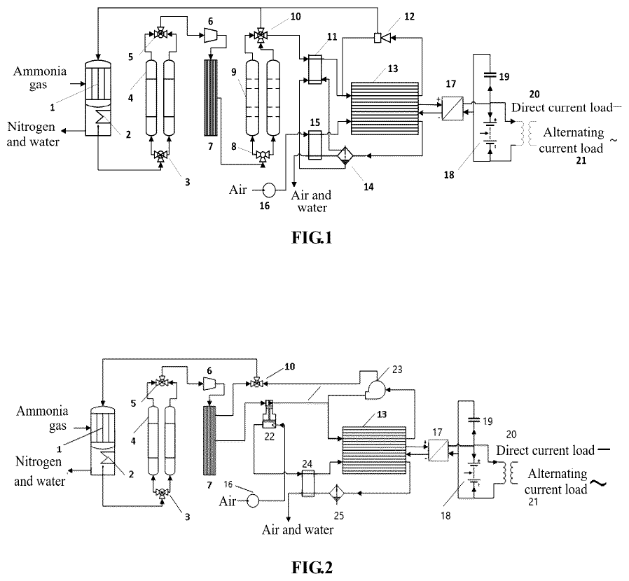

As shown in FIG. 2, this disclosure also provides another fuel cell power generation system, which includes an ammonia decomposition device 1, a heating device 2, an ammonia removal device 4, a fuel cell 13, a conversion device, a battery pack 18, a third membrane humidifier 24, a hydrogen gas circulation pump 23, a pressure pump 22, a second gas-water separator 25 and an air compressor 16. The heating device 2 is mounted inside the ammonia decomposition device 1 and configured to heat gas and catalyst, and the ammonia decomposition device 1 is configured to decompose ammonia gas into hydrogen and nitrogen gases.

The ammonia removal device 4 is communicated with an outtake of the ammonia decomposition device 1 and configured to remove the undecomposed ammonia; and the fuel cell 13 is communicated with the ammonia removal device 4 to generate electric energy by oxidizing hydrogen gas as fuel. The conversion device is connected to the fuel cell 13 to boost a voltage of the fuel cell 13; and the battery pack 18 is configured to store the electric energy generated by the fuel cell 13. The pressure pump 22 is communicated between the ammonia decomposition device 1 and an anode of the fuel cell 13. The air compressor 16 is configured to feed compressed air into the pressure pump 22. The third membrane humidifier 24 is communicated between the pressure pump 22 and a cathode of the fuel cell 13. A first outlet of the fuel cell 13 is communicated with an ingress port of the hydrogen gas circulation pump 23. A first egress port of the hydrogen gas circulation pump 23 is communicated with the intake of the ammonia decomposition device 1, and a second egress port of the hydrogen gas circulation pump 23 is communicated with the anode of the fuel cell 13. A second outlet of the fuel cell 13 is communicated with the ingress of the third gas-water separator, and an egress of the third gas-water separator is communicated with the third membrane humidifier 24. A hydrogen gas pressure pump 6 and a membrane separation device 7 are further provided in the system, wherein the hydrogen gas pressure pump 6 and the membrane separation device 7 are connected between the ammonia removal device 4 and the pressure pump 22 in sequence, and an output port of the membrane separation device 7 is also communicated with the first egress port of the hydrogen gas circulation pump 23.

Compared with Embodiment I, in the fuel cell power generation system provided in the present embodiment, the tail gas generated from the anode of the fuel cell 13 is fed to the anode of the fuel cell 13 via the hydrogen gas circulation pump 23, and adopting exhaust gas from the anode of the fuel cell 13 for humidification can ensure the purity of the hydrogen gas in the anode, but the humidification by the exhaust gas from the anode of the fuel cell 13 is insufficient. For the issue of the humidification of hydrogen gas in the anode of the fuel cell 13 being insufficient, hydrogen gas is pressurized to 0.2 MPa to 0.3 MPa by the pressure pump 22 before entering the fuel cell 13, that is, the anode of the fuel cell 13, and the cathode of the fuel cell 13, that is, the depressurization side, is connected to the air compressor 16, and a pressurizing side outlet of the pressure pump 22 is connected to the piping returned from the hydrogen gas circulation pump 23, and according to the control of specific working conditions, the hydrogen gas circulation pump 23 is used to recover water, and the humidity is controlled in a range of 10% RH to 90% RH. The third membrane humidifier 24 realizes the exchange of humidity between the tail gas of the cathode of the fuel cell 13 and the gas discharged from the air compressor 16 of the fuel cell 13. The hydrogen gas concentration in the anode of the fuel cell 13 in Embodiment I is above 99.97%, and the hydrogen gas concentration in the anode of the fuel cell 13 in Embodiment II is in a range of 90% to 95% purity. It is possible to adopt the solution of Embodiment II, and the anode side of the fuel cell 13 is prone to membrane drying when the stack proton membrane of the fuel cell 13 is relatively thick.

The anode side of the fuel cell 13 has a hydrogen gas circulation pump 23, and the pressure into the stack of the fuel cell 13 is controlled to be 0.2 MPa to 0.3 MPa. The air compressor 16 provides air with an excess ratio of 1.6 to 1.8, the pressure is lowered to 0.12 MPa to 0.22 MPa after passing through a depressurization side of the pressure pump 22. The second gas-water separator 25 separates gas and water from the cathode side of the fuel cell 13, thereby realizing humidity control of the cathode air intake.

The operating process of the fuel cell power generation system described above is as follows:

Ammonia gas enters the ammonia decomposition device 1 after passing through the flow meter, and both the electric heater and the tail gas combustion device supply heat to heat ammonia gas and the catalysts so as to decompose ammonia gas into hydrogen and nitrogen gases. Specifically, the two ways are supplied heat together during startup, and after startup, the electric heating system only plays a role of temperature control, so that ammonia gas is decomposed into hydrogen gas and nitrogen gas in the catalyst bed, and the decomposition rate reaches more than 99.8%, and the decomposition pressure can be increased to 0.5 MPa according to a back-end demand by cooperation with the back-end electric heater and the bed layer with high content of Ni-based catalyst. The decomposed hydrogen and nitrogen gases pass through a first control valve 3 and then enter the ammonia removal device 4, to remove the undecomposed ammonia gas and obtain the hydrogen and nitrogen gases with the ammonia content less than 0.1 ppm. The hydrogen and nitrogen gases after ammonia removal passes through a second control valve 5 and then enters the hydrogen gas pressure pump 6; and the pressurized hydrogen and nitrogen gases enter the membrane separation device 7, to obtain the hydrogen gas with a purity of 90% to 95% which is directly fed into the pressure pump 22, and the pressure pump 22 pressurizes the hydrogen gas according to 1 time to 4 times of the depressurization value of the other side, and the gas that does not penetrate the membrane in the membrane separation device 7 returns to the electric heater and the combustion device for combustion and supplying heat. Hydrogen gas is regulated on pressure through the pressure pump 22, and then enters the anode side of the fuel cell 13 together with hydrogen gas returned from the hydrogen gas circulation pump 23, and the hydrogen gas circulation pump 23 controls the returned humidity and the equivalence ratio entering the stack according to instructions, and intermittently passes the excluded hydrogen gas from the bypass into the electric heater and the combustion device for combustion and supplying heat. The cathode side of the fuel cell 13 has gas supply that comes from the air compressor 16 and then is pumped and passed through the third membrane humidifier 24 and then is obtained. The anode gas of the fuel cell 13 passes through the fuel cell 13, and then returns through the hydrogen gas circulation pump 23. The cathode gas passes the second gas-water separator 25, so that pollution-free air and water are discharged subsequently. The second gas-water separator 25 is used to separate gas from water to ensure humidity control of air entering the stack. The electrical energy output from the fuel cell 13 is connected to the lithium battery pack 18 and a capacitor 19 via the DC/DC converter 17, and is connected to a direct current load 20, an inverter and an alternating current load 21.

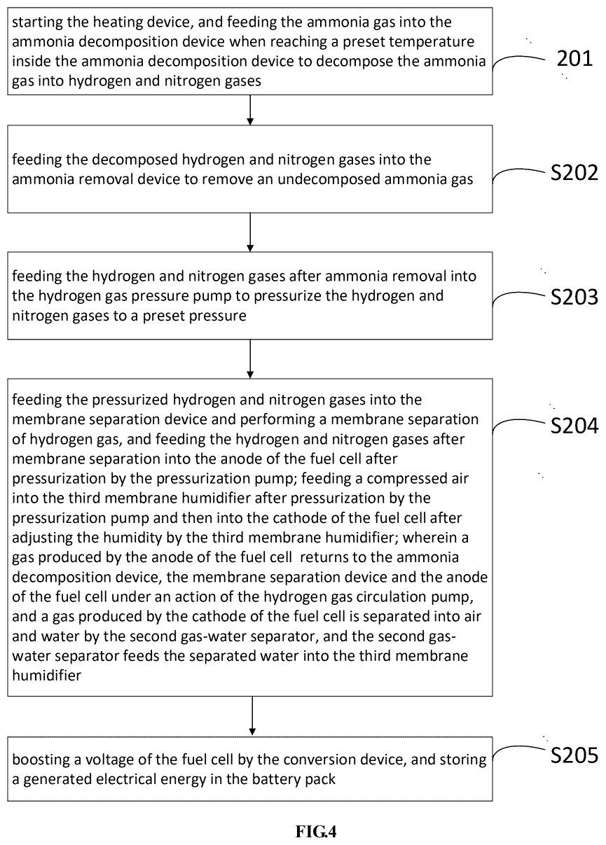

As shown in FIG. 4, a method for controlling the fuel cell power generation system includes the steps as follows:
S201, starting a heating device, and when a preset temperature is reached inside an ammonia decomposition device 1 (the temperature of an upstream portion of the ammonia decomposition device 1 reaches 480° C., and the temperature of a downstream portion reaches 500° C. to 650° C.), feeding ammonia gas into the ammonia decomposition device 1 to decompose ammonia gas into hydrogen and nitrogen gases;
S202, feeding the decomposed hydrogen and nitrogen gases into an ammonia removal device 4 to remove the undecomposed ammonia gas;
S203, feeding the hydrogen and nitrogen gases after ammonia removal into a hydrogen gas pressure pump 6 to pressurize the hydrogen and nitrogen gases to a preset pressure (0.1 MPa to 0.4 MPa);
S204, feeding the pressurized hydrogen and nitrogen gases into a membrane separation device 7 and performing a membrane separation of hydrogen gas, and feeding the hydrogen and nitrogen gases after membrane separation into an anode of the fuel cell 13 after pressurization by the pressurization pump 22; feeding compressed air into a third membrane humidifier 24 after pressurization by the pressurization pump 22 and then into a cathode of the fuel cell 13 after adjusting the humidity by the third membrane humidifier 24; wherein the gas produced by the anode of the fuel cell 13 returns to the ammonia decomposition device 1, the membrane separation device 7 and the anode of the fuel cell 13 under the action of a hydrogen gas circulation pump 23, and the gas produced by the cathode of the fuel cell 13 is separated into air and water by the second gas-water separator 25, and the second gas-water separator 25 feeds the separated water into the third membrane humidifier 24; and
S205, boosting a voltage of the fuel cell 13 by a conversion device, and storing the generated electrical energy in a battery pack 18.

The present embodiment has advantages of high hydrogen storage density, high energy conversion efficiency, low investment cost and low power generation cost; the initial investment and volume of the system can be substantially reduced because the variable pressure adsorption separation device is not required; and the use of hydrogen gas with a purity of 90% to 95% provided through membrane separation, combined with the coupled control of temperature, humidity, pressure, and equivalence ratio of the hydrogen gas pressure pump and the recirculation pump, effectively solves the negative performance impact caused by nitrogen gas accumulation in the existing fuel cell system; and moreover, the use of energy recovery of the air compressor as the hydrogen gas side pressurization, effectively solves a difficult issue of insufficient pressure of hydrogen and nitrogen gases in the ammonia decomposition hydrogen production system; and if in the embodiment lack of the membrane separation device, the design method can play an even more important role. In application scenarios such as base station power supply, generator sets, power station peak regulation, mining trucks and heavy trucks, and electric ships, this embodiment has advantages of cross-season and long-time energy storage, high power generation efficiency, low cost per kW·h, small initial investment, low operation and maintenance pressure, and no pollutant emission, etc.

Obviously, the embodiments described above are merely examples for the purpose of clear illustration, and are not a limitation of the embodiments. For the person skilled in the art, other variations or changes in different forms may be made on the basis of the above description. It is neither necessary nor possible to exhaust all of the embodiments herein. The obvious variations or changes derived therefrom are still within the scope of this disclosure.

1. A fuel cell power generation system, comprising:
an ammonia decomposition device and a heating device disposed in the ammonia decomposition device, wherein the heating device is configured to heat gas and catalyst in the ammonia decomposition device, and the ammonia decomposition device is configured to decompose ammonia gas into hydrogen and nitrogen gases;
an ammonia removal device communicated with an outtake of the ammonia decomposition device and configured to remove undecomposed ammonia gas;
a fuel cell communicated with the ammonia removal device and configured to generate electric energy by oxidizing hydrogen gas as fuel;
a conversion device connected to the fuel cell and configured to boost a voltage of the fuel cell; and
a battery pack configured to store the electric energy generated by the fuel cell;
wherein the system further comprises a first membrane humidifier, a second membrane humidifier, a first gas-water separator, and an air compressor, the first membrane humidifier is communicated between the ammonia decomposition device and an anode of the fuel cell, the second membrane humidifier is communicated between the air compressor and a cathode of the fuel cell, the air compressor is configured to feed compressed air into the cathode of the fuel cell, a first outlet of the fuel cell is communicated with the anode of the fuel cell, a second outlet of the fuel cell is communicated with an ingress of the first gas-water separator, a first egress of the first gas-water separator is communicated with the first membrane humidifier, and a second egress of the first gas-water separator is communicated with the second membrane humidifier;
the system further comprises a membrane separation device and a variable pressure adsorption separation device, an input port of the variable pressure adsorption separation device is communicated with an output port of the membrane separation device, an output port of the ammonia removal device is communicated with an input port of the membrane separation device, and an output port of the variable pressure adsorption separation device is communicated with the anode of the fuel cell through the first membrane humidifier.

2. (canceled)

3. The fuel cell power generation system in accordance with claim 1, wherein the system further comprises a hydrogen gas pressure pump connected between the output port of the ammonia removal device and the input port of the membrane separation device.

4. The fuel cell power generation system in accordance with claim 3, wherein the system further comprises an ejector, an inlet port of the ejector is communicated with the first outlet of the fuel cell, a first outlet port of the ejector is individually communicated with the output port of the variable pressure adsorption separation device and an intake of the ammonia decomposition device, and a second outlet port of the ejector is communicated with the anode of the fuel cell.

5. The fuel cell power generation system in accordance with claim 4, wherein the heating device comprises an electric heater and a tail gas combustion device, and the ammonia decomposition device is internally separated into a first decomposition space and a second decomposition space that are capable of conducting heat, and the tail gas combustion device is mounted in the first decomposition space, and the electric heater is mounted in the second decomposition space; and the first decomposition space is individually communicated with a first intake of the ammonia decomposition device and the first outlet port of the ejector, the second decomposition space is communicated with a second intake of the ammonia decomposition device, and the ammonia gas enters the second decomposition space, and both the first decomposition space and the second decomposition space are communicated with the outtake of the ammonia decomposition device.

6. The fuel cell power generation system in accordance with claim 5, wherein the second decomposition space is filled with two catalysts in a flow direction of the ammonia gas, a proportion of a first catalyst gradually increases toward an upstream side of the ammonia gas, and a proportion of a second catalyst gradually increases toward a downstream side of the ammonia gas.

7. The fuel cell power generation system in accordance with claim 6, wherein the first catalyst is a Ru-based catalyst, and the second catalyst is a Ni-based catalyst, and each catalyst is distributed and filled in a gradient, and each catalyst has a particle size of 0.5 mm to 3 mm.

8. A fuel cell power generation system, comprising:
an ammonia decomposition device and a heating device disposed in the ammonia decomposition device, wherein the heating device is configured to heat gas and catalyst in the ammonia decomposition device, and the ammonia decomposition device is configured to decompose ammonia gas into hydrogen and nitrogen gases;
an ammonia removal device communicated with an outtake of the ammonia decomposition device and configured to remove undecomposed ammonia gas;
a fuel cell communicated with the ammonia removal device and configured to generate electric energy by oxidizing hydrogen gas as fuel;
a conversion device connected to the fuel cell and configured to boost a voltage of the fuel cell; and
a battery pack configured to store the electric energy generated by the fuel cell;
wherein the system further comprises a pressure pump, a hydrogen gas circulation pump, a third membrane humidifier, a second gas-water separator and an air compressor, and an inlet of the pressure pump is connected to an output port of the ammonia removal device, and an outlet of the pressure pump is connected to an anode of the fuel cell, and the air compressor is configured to feed compressed air into the pressure pump; and
the third membrane humidifier is communicated between the pressure pump and a cathode of the fuel cell; a first outlet of the fuel cell is communicated with an ingress port of the hydrogen gas circulation pump, a first egress port of the hydrogen gas circulation pump is communicated with the intake of the ammonia decomposition device, and a second egress port of the hydrogen gas circulation pump is communicated with the anode of the fuel cell, a second outlet of the fuel cell is communicated with an ingress of the second gas-water separator, and an egress of the second gas-water separator is communicated with the third membrane humidifier;
the system further comprises a hydrogen gas pressure pump and a membrane separation device, wherein a first output port of the membrane separation device is communicated with the first egress port of the hydrogen gas circulation pump, a second output port of the membrane separation device is communicated with the pressure pump, an ingress port of the hydrogen gas pressure pump is communicated with the output port of the ammonia removal device, and the egress of the hydrogen gas pressure pump is communicated with an input port of the membrane separation device.

9. (canceled)

10. A method for controlling a fuel cell power generation system, wherein the method is suitable for the fuel cell power generation system in accordance with claim 6, and the method comprises steps as follows:
S101, starting the heating device, and feeding the ammonia gas into the ammonia decomposition device when reaching a preset temperature inside the ammonia decomposition device, to decompose the ammonia gas into hydrogen and nitrogen gases;
S102, feeding the decomposed hydrogen and nitrogen gases into the ammonia removal device to remove an undecomposed ammonia gas;
S103, feeding the hydrogen and nitrogen gases after ammonia removal into the hydrogen gas pressure pump to pressurize the hydrogen and nitrogen gases to a preset pressure;
S104, feeding the pressurized hydrogen and nitrogen gases into the membrane separation device and performing a first separation of hydrogen gas, and feeding the hydrogen and nitrogen gases after the membrane separation into the variable pressure adsorption separation device and performing a second separation of the hydrogen gas;
S105, feeding the separated hydrogen and nitrogen gases into the anode of the fuel cell after adjusting humidity by the first membrane humidifier, and feeding a compressed air into the cathode of the fuel cell after adjusting humidity by the second membrane humidifier; wherein a gas produced by the anode of the fuel cell returns to the ammonia decomposition device, the variable pressure adsorption separation device, and the anode of the fuel cell under an action of the ejector, and a gas produced by the cathode of the fuel cell is separated into air and water by the first gas-water separator, and the first gas-water separator individually feeds the separated water into the first membrane humidifier and the second membrane humidifier; and
S106, boosting the voltage of the fuel cell by the conversion device, and storing a generated electrical energy in the battery pack.

11. A method for controlling a fuel cell power generation system, wherein the method is suitable for the fuel cell power generation system in accordance with claim 8, and the method comprises steps as follows:
S201, starting the heating device, and feeding the ammonia gas into the ammonia decomposition device after reaching a preset temperature inside the ammonia decomposition device, to decompose the ammonia gas into hydrogen and nitrogen gases;
S202, feeding the decomposed hydrogen and nitrogen gases into the ammonia removal device to remove an undecomposed ammonia gas;
S203, feeding the hydrogen and nitrogen gases after ammonia removal into the hydrogen gas pressure pump to pressurize the hydrogen and nitrogen gases to a preset pressure;
S204, feeding the pressurized hydrogen and nitrogen gases into the membrane separation device and performing a membrane separation of hydrogen gas, and feeding the hydrogen and nitrogen gases after membrane separation into the anode of the fuel cell after pressurization by the pressurization pump; feeding a compressed air into the third membrane humidifier after pressurization by the pressurization pump and then into the cathode of the fuel cell after adjusting humidity by the third membrane humidifier; wherein a gas produced by the anode of the fuel cell returns to the ammonia decomposition device, the membrane separation device and the anode of the fuel cell under an action of the hydrogen gas circulation pump, and a gas produced by the cathode of the fuel cell is separated into air and water by the second gas-water separator, and the second gas-water separator feeds the separated water into the third membrane humidifier; and
S205, boosting the voltage of the fuel cell by the conversion device, and storing a generated electrical energy in the battery pack.
